(19) United States
(12) Patent Application Publication
(10) Pub. No.: US 2024/0104184 A1
(43) Pub. Date: Mar. 28, 2024

(54) SYSTEMS AND METHODS FOR ACCESS CONTROL

(71) Applicant: SE.QR ADVANCEMENTS PTY LTD, South Hurstville (AU)

(72) Inventor: Gary Siu Gwan TONG, South Hurstville (AU)

(21) Appl. No.: 18/468,403

(22) Filed: Sep. 15, 2023

(30) Foreign Application Priority Data
Sep. 23, 2022 (AU) 2022902758

(51) Int. Cl. G06F 21/33

(52) U.S. Cl. CPC G06F 21/33

(57) ABSTRACT

Disclosed herein is a system for access control. The system comprises an access authority configured to: receive a request associated with a user; determine whether the user is authorised to be granted access; in response to determining that the user is authorised to be granted access, digitally sign access authorisation data comprising a cryptographic key of the user; and send the signed access authorisation data to a user device associated with the user. The system further comprises an access controller configured to: receive from the user device signed authentication data comprising the signed access authorisation data; verify access criteria comprising verifying the signature of the signed access authorisation data, and verifying the signature of the signed authentication data using the cryptographic key of the user; and, in response to verifying the access criteria, grant the access request. Also disclosed herein are methods for access control, methods for sending data, and methods for receiving data.

### TECHNICAL FIELD

The present invention relates to systems and methods for access control.

### BACKGROUND

An access control system restricts who can access a physical space, a bank account, confidential information, or any other secured amenity. A typical access control system is an electronic system including an electronic device to which a person provides their credentials. The electronic device checks that the credentials are valid and either grants or denies access.

In some cases, the credentials include a code, which the person provides to the electronic device through a keypad or by presenting an electronic key, such as a key fob. Codes, however, can be lost or stolen, and electronic keys can also be copied, compromising the security of the access control system.

In other cases, the credentials include the person's authentication information, such as a username and password. The electronic device normally sends the authentication information to a central authority, which then instructs the access control system to grant or deny access. This arrangement however is not always practical or possible because it requires the electronic device to be connected to a communication network, such as the Internet, to permit communication between the electronic device and the central authority. Moreover, stolen or leaked authentication information can compromise the security of the access control system until the authentication information is changed.

It is desired to address or ameliorate one or more disadvantages or limitations associated with the prior art, or to at least provide a useful alternative.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

### SUMMARY

According to one example aspect, there is provided a system for access control. The system comprises an access authority configured to: receive a request associated with a user; determine whether the user is authorised to be granted access; in response to determining that the user is authorised to be granted access, digitally sign access authorisation data comprising a cryptographic key of the user; and send the signed access authorisation data to a user device associated with the user. The system further comprises an access controller configured to: receive from the user device signed authentication data comprising the signed access authorisation data; verify access criteria comprising verifying the signature of the signed access authorisation data, and verifying the signature of the signed authentication data using the cryptographic key of the user; and, in response to verifying the access criteria, grant the access request.

In certain embodiments, the access controller is configured to verify the signature of the signed authentication data through public-key cryptography. In certain embodiments, the cryptographic key of the user is a user public key, and the access controller is configured to verity that the signature of the signed authentication data was generated with a user private key, wherein the user public key and the user private key form a cryptographic key pair.

In certain embodiments, the access controller is configured to verify the signature of the signed access authorisation data through public-key cryptography. In certain embodiments, the access authority is configured to generate the signature of the signed access authorisation data with an authority private key, and the access controller is configured to access an authority public key and to verify the signature of the signed access authorisation data using the authority public key, wherein the authority public key and the authority private key form a cryptographic key pair. In certain embodiments, the access authority is configured to generate the cryptographic key pair comprising the authority public key and the authority private key. In certain embodiments, the access controller is configured to receive the authority public key from the access authority, and to store the authority public key in a memory of the access controller.

In certain embodiments, the access authorisation data comprises a location identifier indicative of a location which the user is authorised to access, and the access criteria further comprise verifying that the location identifier corresponds to a location associated with the access controller. In certain embodiments, the access authority is further configured to: determine a request time indicative of the time when the access request is received; and, in response to determining that the request time is outside an access period, set the access authorisation data to indicate an invalid status. In certain embodiments, the access criteria further comprise verifying that the status of the authorisation data is not invalid.

In certain embodiments, the access controller comprises an image sensor configured to read one or more optical labels from a display device of the user device, wherein the one or more optical labels represent the signed authentication data. In certain embodiments, the image sensor is configured to read a sequence of two or more optical labels from the display device, wherein each of the two or more optical labels encodes a data packet representing a portion of the signed authentication data. In certain embodiments, each optical label in the sequence encodes a position number representing the position of the data packet encoded by the respective optical label in an ordered arrangement of the data packets encoded by the two or more optical labels representing the signed authentication data, and the access controller is configured to reconstruct the signed authentication data by ordering the two or more data packets based on their position numbers.

In certain embodiments, each of the one or more optical labels encodes an error-detecting code, and, for each optical label read, the access controller is configured to detect the presence of an error in the data derived from reading the optical label using the error-detecting code, to re-read the optical label when an error in the data is detected, and to replace the data derived from the previous reading of the optical label with data derived from re-reading the optical label. In certain embodiments, the error-detecting code is a cyclic redundancy check (CRC). In certain embodiments, the two or more optical labels are encoded as erasure codes generated from the signed authentication data.

In certain embodiments, each of the optical labels is a matrix barcode. In certain embodiments, the matrix barcode is a quick response (QR) code.

In certain embodiments, to determine whether a user is authorised to be granted access, the access authority is configured to receive access credentials of the user, and to determine the validity of the access credentials. In certain embodiments, the access credentials comprise a username and a password associated with an account of the user.

In certain embodiments, the access authorisation data further comprises timing data, and the access criteria further comprise verifying that the signed access authorisation data is not expired based on the timing data of the signed access authorisation data. In certain embodiments, the signed authentication data further comprises timing data, wherein the access criteria further comprise verifying that the signed authentication data is not expired based on the timing data of the signed authentication data.

In certain embodiments, the signed authentication data further comprises authentication information of the user.

In certain embodiments, the access controller is operatively coupled to a lock, and the access controller is configured to grant the access request by unlocking the lock.

According to another example aspect, there is provided a system for access control. The system comprises an access authority and an access controller. The access authority is configured to: determine or assess the validity of access credentials of a user; in response to determining that the access credentials are valid, digitally sign a first message, wherein the first message comprises a user public key; and send the first message to a user device. The access controller is configured to: receive a second message digitally signed with a user private key, wherein the second message comprises the first message; verify that the first message is signed by the access authority; in response to verifying the first message is signed by the access authority, verify that the second message is signed with the user private key by using the user public key; and, in response to verifying that the second message is signed with the user private key, grant access to the user.

In certain embodiments, the access authority is configured to access an authority private key and to digitally sign the first message with the authority private key, and the access controller is configured to access an authority public key and to verify that the first message is signed by the access authority by using the authority public key.

According to another example aspect, there is provided a method for access control. The method comprises: receiving an access request associated with a user; determining whether the user is authorised to be granted access; in response to determining that the user is authorised to be granted access, generating an authority signature by digitally signing access authorisation data comprising a cryptographic key of the user; sending the signed access authorisation data to a user device associated with the user; receiving, from the user device, signed authentication data comprising the signed access authorisation data; verifying access criteria comprising verifying the authority signature of the signed access authorisation data, and verifying that the signature of the signed authentication data is a digital signature of the user using the cryptographic key of the user; and, in response to verifying the access criteria, granting the access request.

### BRIEF DESCRIPTION OF THE DRAWINGS

Some embodiments of the present invention are described below, by way of example only, with reference to the accompanying drawings, in which:

FIG. 1 shows a block diagram of an example system for access control;

FIG. 2 shows a diagram of an example operation of the system of FIG. 1;

FIG. 3 shows a flowchart of an example method for sending a message;

FIG. 4 shows a flowchart of an example method for receiving a message; and

FIG. 5 shows a flowchart of an example method for access control.

### DETAILED DESCRIPTION

Embodiments of the invention provide systems and methods for access control. The system comprises an access authority configured to receive an access request associated with a user and to determine whether the user is authorised or permitted to be granted access. The access authority is further configured to digitally sign access authorisation data, or a first message, and to send or provide the signed access authorisation data to a user device associated with the user. The system further comprises an access controller or terminal configured to receive or obtain from the user device authentication data, or a second message, which is digitally signed by the user, and which comprises the access authorisation data. The access controller is further configured to grant the access request in response to verifying at least the digital signature of the user and the digital signature of the access authority.

The access controller may be configured to verify the digital signature of the user and/or the signature of the access authority through cryptography. In some examples, the access authorisation comprises a user token, such as a cryptographic key of the user, and the access controller is configured to verify the digital signature of the user by using the user token. In some examples, the system employs public-key or asymmetric cryptography. In other examples, the system employs secret-key or symmetric cryptography, or a combination of symmetric and asymmetric cryptography.

Cryptographic verification can be used for authentication and for assessing the integrity of the data provided to the access controller. In some examples, cryptographic verification used by the access controller allows it to authenticate users and to validate their access permission without being connected to a telecommunication system, such as the Internet (i.e. while operating “offline”).

The access controller may be configured to receive authentication data from the user device by reading one or more optical labels, such as quick response (QR) codes, displayed on a display of the user device, so that the user device (and therefore the user) may need to be near or in proximity to the access controller when requesting access from the access controller, further enhancing the security of the system. The optical labels may comprise dynamic or dynamically-generated codes, which may be more difficult to clone than static codes due to the time limit of their validity.

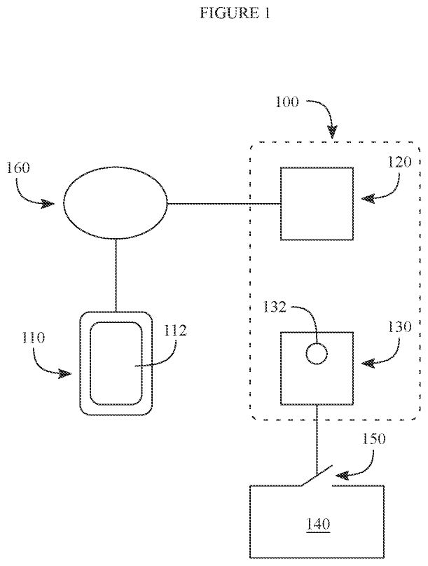

FIG. 1 shows an example system 100 for access control and a user device 110 through which a user may interact with system 100. User device 110 is associated with or operated by a user of system 100.

System 100 comprises an access authority 120 and an access controller 130. Access controller 130 is configured to grant or deny access to a resource or amenity 140 by operating barrier or locking device 150. Resource 140 may be a physical resource, such as a physical space or a tangible item, or a non-physical resource, such as information or a bank account. Similarly, barrier 150 may be a physical barrier, such as a door, or a non-physical barrier, such as a firewall, as appropriate to secure access to resource 140.

In some examples, access controller 130 is installed at a physical location and is located remotely of access authority 120.

Each of user device 110, access authority 120, and access controller 130 may comprise a processing system (i.e. system 100 may comprise two processing systems and user device a third processing system). The processing systems may run the same or different operating systems. For example, user device 110 may run iOS or Android, while access controller 130 may run a Linux operating system. In some examples, user device 110 comprises a portable computer device, such as a smartphone or a tablet computer. In some examples, access authority 120 runs a server. In some examples, access authority 120 comprises a distributed system, such as a cloud computing system.

User device 110 and access authority 120 are communicatively coupled to each other through a telecommunication network 160, such as the Internet, to which they are both connected.

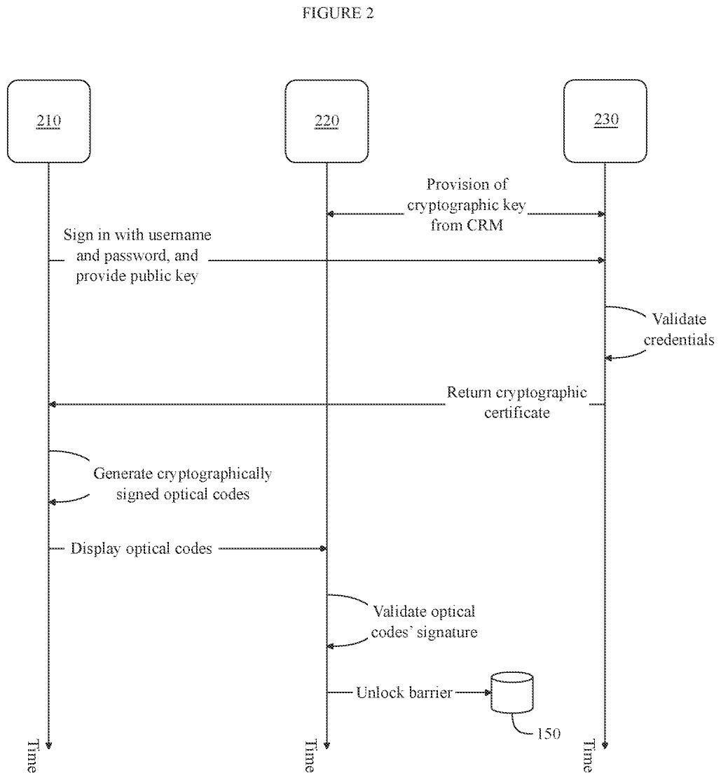

The operation of system 100 is described next with reference to the diagram in FIG. 2, which shows tasks performed by a first or user application 210, a second or scanner application 220, and a third or cloud application 230. In the description that follows, application 210 is an application program configured to run on user device 110, application 220 is an application program configured to run on access controller 130, and application 230 is an application program configured to run on access authority 120.

Access authority 120 is provided with a private key, and access controller 130 is provided with a public key. These keys are herein called the authority (or first) private and public keys to distinguish them from a different set of keys referenced below. The authority private key and the authority public key form a cryptographic key pair, so that a digital signature performed with the private key can be verified only by using the public key, and vice versa.

In some examples, the authority key pair is generated by access authority 120, which then sends the authority public key to access controller 130 through telecommunication network 160 or through any other data transfer means. Access controller 130 may comprise a memory or data storage device, such as a main memory or a disk drive, configured to store the received authority public key to allow access controller 130 to access the authority public key without having to remain connected to telecommunication network 160, or without having to continuously be in communication with access authority 120. In other examples, the authority key pair is generated by access controller 130 or by any other means, and a respective key is provided to access authority 120 and/or access controller 130.

Another cryptographic key pair is provided to user device 110, comprising user (or second) private and public keys, different from the authority key pair. The user key pair may be generated by user device 110 or by any other means which then supplies both keys to user device 110.

In some examples, the authority key pair and the user key pair are generated through an Edwards-curve Digital Signature Algorithm (EdDSA), such as Ed25519. In other examples, the authority key pair and the user key pair are generated through any other cryptographic key generation method, such as the Rivest-Shamir-Adleman (RSA) algorithm.

In operation, access authority 120 is configured to receive or access an access request associated with the user either through telecommunication network 160 or through any other means. In some examples, the access request is generated by or received from user device 110. In some examples, the access request comprises the user public key and access credentials of the user. In other examples, the user public key and the access credentials may be received by access authority 120 separately from the access request. The access credentials may comprise a username (such as an email address of the user) and a password, associated with a user account of the user on system 100.

Access authority 120 is configured to determine whether the user is authorised to be granted access to resource 140, for example by determining or assessing whether the access credentials are valid or correct. In some examples, the access credentials are deemed valid if a user account associated with the credentials exists and if the user associated with the user account has access permission. Access authority 120 may comprise or be connected to a database, such as a customer relationship management (CRM) system, holding user information that can be accessed or retrieved using the access credentials. In some examples, user accounts can be created by users and/or by system administrators, although only administrators can modify users' access permissions.

If the access credentials are determined to be valid, access authority 120 is configured to digitally sign access authorisation data, or a first message or file, with the authority private key. The access authorisation data comprises the user public key. In some examples, the access authorisation data further comprises authority timing data, such as a timestamp or an expiration time, indicative of a time at which the signature of access authority 120 is set to expire (e.g. 15 minutes, 60 minutes, or any other period after the time at which the access authorisation is signed). The expiration time may be set or changed depending on the level of security required. Therefore, in some examples, the signed access authorisation data comprises three data items: the user public key, the timestamp, and the signature of access authority 120. The signature of access authority 120 may be generated by applying a signing algorithm with the authority private key to the data to be signed or to an equivalent representation, such as a hash value, of the data to be signed. Access authority 120 is then configured to send the signed access authorisation data to user device 110.

User device 110, after receiving the signed access authorisation data, is configured to digitally sign authentication data, or a second message or file, with the user private key. The authentication data comprises the signed access authorisation data. In some examples, the authentication data further comprises authentication information of the user (e.g. email address, first name, last name) In some examples, the authentication data further comprises a second copy of the user public key, being a copy of the user public key other than the one in the access authorisation data, and therefore being unsigned by access authority 120. In some examples, the authentication data further comprises user timing data, such as a timestamp or an expiration time at which the authentication data expires (e.g. 5 minutes after the time at which the authentication data is created).

User device 110 may be further configured to check whether the signature of access authority 120 has expired based on the authority timing data. If it has expired, user device 110 may be configured to request access authority 120 to re-sign the access authorisation data. In some examples, this check and request happen automatically in the background, without user input. In response to being requested to re-sign the access authorisation data, access authority 120 may be configured to again determine whether the user's access credentials are valid or correct. For example, if the user's account has been disabled since the previous signing of the access authorisation data, access authority 120 may not re-sign the access authorisation data. Alternatively, if the user's account is still valid and has access permissions, access authority 120 may re-sign the access authorisation data and send the newly signed access authorisation data to user device 110.

Access controller 130 is configured to receive or access the signed authentication data. In some examples, the signed authentication data is received from user device 110 by reading optical labels displayed by user device 110. In other examples, the signed authentication data is received from user device 110 through telecommunication network 160 or through any other means of data transfer. Access controller 130 may be further configured to log or keep a record of access requests by the user using the authentication information of the user in the signed authentication data.

Access controller 130 is configured to verify one or more access criteria. One access criterion comprises verifying that the access authorisation data, included in the authentication data, is signed by access authority 120. Access controller 130 may use the authority public key (which may be stored in its memory) to verify the signature in the access authorisation data.

Another access criterion comprises verifying that the signed authentication data includes a user signature of the user generated with the user private key. Access controller 130 may use the user public key contained in the signed access authorisation data to verify the signature of the authentication data.

If the access authorisation data comprises the timing data, another access criterion comprises verifying that the authority signature in the access authorisation data is expired based on the timing data in the access authorisation. In some examples, another access criterion comprises verifying that the access authorisation data and/or the authentication data have not expired.

Another example access criterion takes into account a location where the user requests access. For example, system 100 may comprise two or more access controllers, like access controller 130, located at two or more different locations. The access controllers may control access to two or more respective resources, like resource 140, or they may control access to different parts of single resource 140. The location of an access controller may be provided or registered with the access controller, so that the access controller can access the location with which it is associated. Since the user may not be authorised to access all the locations, in some examples, the access authorisation data comprises a location identifier indicative of a location which the user is authorised to access, and an access criterion comprises verifying that the location identifier corresponds to a location associated with the access controller which has received the signed authentication data. The location identifier for the user may be stored in the CRM or otherwise provided to access authority 120.

Another example access criterion takes into account a time when the user requests access. For example, the user may be permitted to access resource 140 only during a specific access period, such as from 9 am to 5 pm. Access authority 120 may consequently be configured to determine a request time indicative of the time when the access request is received. In response to determining that the request time is outside the access period for the user, access authority 120 may be configured to set the access authorisation data to indicate an invalid status. An access criterion may comprise verifying that the status of the authorisation data is not invalid. For example, if the user requests access during their allowed period, as specified in the CRM or otherwise provided to access authority 120, they are provided with valid access authorisation data; otherwise, they are provided with invalid access authorisation data, so that user device 110 is still able to provide the signed authentication data to access controller 130, but the access authorisation data contained therein is fake, which access controller 130 may be configured to detect to deny the access request.

If all the access criteria are verified, or confirmed to be satisfied, access controller 130 is configured to grant the user's access request to resource 140. To grant the access request, access controller 130 may be configured to unlock and/or open barrier 150, or to generate access grant data to be sent to and acted on by another device. For example, when barrier 150 is a door, access controller 130 may be electrically coupled to an electronic lock of the door—to unlock the door, access controller 130 may be configured to supply a voltage to the electronic lock, causing it to open. If any one of the access criteria is not verified, or is confirmed to not be satisfied, access controller 130 is configured to deny the user's access request to resource 140. To deny access, access controller 130 may take no action, so that barrier 150 remains locked and/or closed, or it may generate access denial data to be sent to and acted on by another device.

Since all the access criteria must be satisfied before access can be granted, upon determining that one of the access criteria is not satisfied, access controller 130 may not proceed to verify other access criteria that are yet to be verified. For example, access controller may verify a next access criterion only in response to determining that a current access criterion is satisfied.

Access controller 130 does not need to be connected to the Internet or any other telecommunication network to verify that the user is authorised to access resource 140. In some examples, access controller 130 only needs to connect to a telecommunication network in order to obtain the authority public key, and thereafter can disconnect from the network and operate offline. User device 110, or an application which manages the interaction of user device 110 with system 100, has its own cryptographic key pair: the user public key is signed by access authority 120, and the user private key is used to sign the authentication data provided to access controller 130, allowing access controller 130 to initially trust access authority 120, which in turn trusts user device 110, so that signature verifications can be done offline.

Moreover, when the access authorisation data and the authentication data are valid only for a limited period, the leakage or theft of any of these two data objects (e.g. due to the communication link between user device 110 and access authority 120 being monitored) may compromise the security of system 100 only until the expiry of the validity period. The limited validity period of the access authorisation data also allows the deactivation of a user's access permission without the need for access controller 130 to be connected to a telecommunication network.

While the public keys of the user and of access authority 120 may not be required to be kept secret and may be freely disclosed, the private keys may need to be kept secret or confidential in order to preserve the security of system 100. Therefore, in some examples, user device 110 and/or access authority 120 are configured to periodically regenerate their respective key pairs to preserve security in the event that access authority 120 is hacked or the private keys are leaked. Therefore, in some examples, access controller 130 is configured to periodically connect to a telecommunication network to obtain the new authority public key.

In other examples, in order to authenticate the user, access controller 130 is configured to send to access authority 120 a copy of the user public key that is in the authentication data and that is not signed by access authority 120. Access authority 120 may then be configured to compare the copy of the user public key received from access controller 130 with the copy of the user public key received from user device 110, and, if they match, to send a confirmation to access controller 130. In order to execute this alternative authentication process, access controller 130 may need to be communicatively coupled with access authority 120, for example, by being connected to telecommunication network 160.

In other examples, alternative or additional protocols may be used to secure the exchange of messages between user device 110, access authority 120, and/or access controller 130. For example, in an alternative implementation, access authority 120 may encrypt the access authorisation data, instead of signing it, using, for example, an encryption key derived from the user public key, and may then send the encrypted access authorisation data to user device 110 in response to determining that the user is authorised to be granted access. User device 110 may then be configured to decrypt the encrypted access authorisation data before signing the authentication data and sending it to access controller 130.

Referring again to FIG. 1, access controller 130 comprises an image sensor 132, such as a camera, a scanner, or a reading device. Image sensor 132 is configured to read one or more optical labels from a display device 112, such as an electronic visual display, of user device 110. In some examples, the optical labels are matrix barcodes, such as QR codes. The optical labels may represent or encode the authentication data, so that access controller 130 can receive or obtain the authentication data through one or more optical labels.

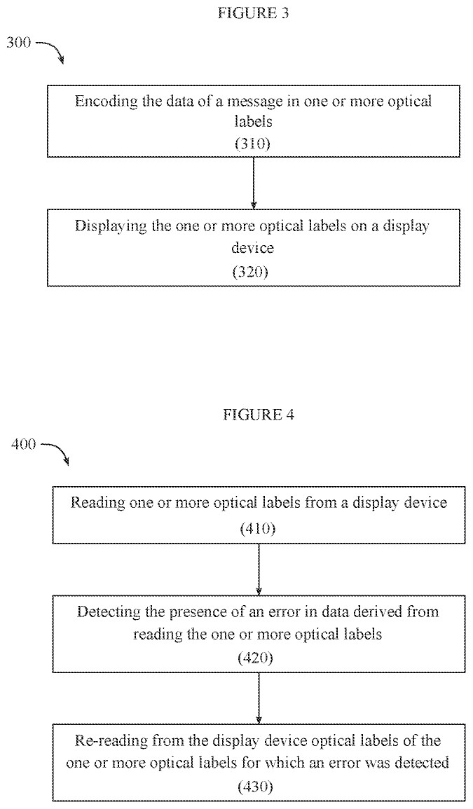

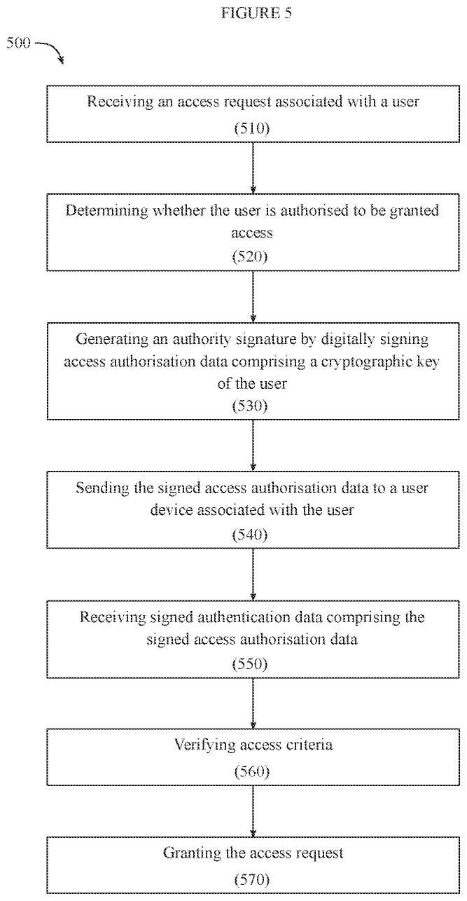

The method of communication between user device 110 and access controller 130 is described next with reference to FIGS. 3 and 4.

A processing system, such as user device 110, may be configured to perform the steps of method 300 for sending or providing a data object, such as a message or file.

At step 310, the method comprises encoding the data of the message in one or more optical labels. The number of optical labels may depend on the size of the message and on the data capacity of the optical labels. For example, if the size of the message exceeds the capacity of a single optical label, the processing system may be configured to split or divide the data of the message into two or more packets or slices of data (where the size of each data packet is less than or equal to the data capacity of an optical label), and to encode each data packet or a combination of two or more data packets, depending on the encoding process, in one optical label.

In some examples, before being encoded in the optical labels, each data packet is supplemented with additional data, such as by being padded with header data. When the message is divided into two or more data packets, the additional data comprises a position or order number, representing the position of a particular data packet in an ordered arrangement of data packets that constitute the message. The additional data may further include an error-detecting code, such as a cyclic redundancy check (CRC).

In some examples, the one or more optical labels are encoded using erasure codes generated from the data of the message, so that the original message can be recovered from a subset of the one or more optical labels. In some examples, the erasure codes are fountain codes. In some examples, the fountain codes are Luby transform (LT) codes.

At step 320, the method comprises displaying or flashing the one or more optical labels on a display device, such as an electronic visual display or screen. When two or more optical labels are displayed, the optical labels may be displayed sequentially, such as one at a time. In some examples, each optical label in the sequence is displayed for 0.075 seconds. The display of the sequence may be repeated one or more times.

A processing system, such as access controller 130, may be configured to perform the steps of method 400 for receiving or reading a message or file.

At step 410, the method comprises reading or scanning, using an image sensor, one or more optical labels from a display, such as an electronic visual display or screen. The one or more optical labels represent a message. When two or more optical labels are present, they may be read sequentially.

At step 420, the method comprises detecting the presence of an error in, or detecting corruption of, the data derived from or generated by reading the one or more optical labels. Error detection may be performed by using or checking an error-detecting code, such as a CRC, encoded in each optical label.

At step 430, the method comprises re-reading or re-scanning from the display device, using the image sensor, any optical label for which an error was detected. The data with the error (i.e. the “old data”) may then be discarded or replaced with the data generated by re-reading the same optical label (i.e. the “new data”). Steps 420 and 430 may be repeated until data that is error- or corruption-free is acquired for each of the one or more optical labels.

When two or more optical labels are present, method 400 may further comprise a step of reconstructing the message from the data packets derived from reading the two or more optical labels. To do this, the data packets may be arranged or ordered based on a position number encoded in each optical label. The ordered data packets may then be combined or synthesised to form the data of the original message. Since the data packet encoded in each optical label is numbered, it is not necessary for the optical labels to be read in sequential order to reconstruct the message. If the data packet of an optical label is corrupted during transfer or if the image sensor misses or misreads an optical label, the relevant optical label may simply be read again in the next iteration or rotation of the display of the sequence. The message is then reconstructed when data packets of all the optical labels in the sequence are obtained, regardless of the order in which they are obtained.

Although optical labels may have a built-in or native error-correction capability (QR codes, for example, typically have four levels of error correction), the described method, whereby errors are detected using an external error-detection code (e.g. CRC), bad data is discarded, and the relevant optical labels are re-read, may in some examples be faster and more reliable than using the optical labels' built-in error correction codes. In addition, the density of the optical labels may be reduced when their built-in error-correction is not used, making them easier to read. However, in other examples, the method may comprise detecting and/or to correcting errors in the data generated by reading the optical labels using a built-in capability of the optical labels (e.g. not CRC), without re-reading the optical labels.

In the context of system 100, although error detection using, for example, CRC is fast, it may not be cryptographically reliable. On the other hand, although cryptographic signature verification can be used to detect whether a message was altered (either maliciously by human intervention or unintentionally due to noise), it may be slower and more resource-intensive than a CRC check. Therefore, by performing a CRC check on the data of each separate optical label, and by then performing a single cryptographic verification of the signature of the authentication data, system 100 may be able to provide a fast and efficient way of detecting data errors without compromising security.

In other examples, when the optical labels are encoded using erasure codes such as fountain codes representing the message, the optical labels may be continuously read and decoded until the original message can be reconstructed. Due to the characteristics of erasure codes, not every erasure code that constitutes the message must be read to reconstruct the original message, so that even if some optical labels are missed, the message may be reconstructed without requiring the missed labels to be re-read.

It is to be understood that methods 300 and 400, in addition to being suitable for transferring authentication data from a user device to an access controller as described above, may be suitable for transferring any kind of information between a first device comprising a display device and a second device comprising an image sensor. For example, methods 200 and 300 may be used to communicate an advertising message or video from an electronic advertising board to a smartphone.

FIG. 5 shows a flowchart of an example method 500 for access control.

Step 510 of method 500 comprises receiving an access request associated with a user.

Step 520 of method 500 comprises determining whether the user is authorised to be granted access.

Step 530 of method 500 comprises generating, in response to determining that the user is authorised to be granted access, an authority signature by digitally signing access authorisation data comprising a cryptographic key of the user.

Step 540 of method 500 comprises sending the signed access authorisation data to a user device associated with the user.

Step 550 of method 500 comprises receiving signed authentication data comprising the signed access authorisation data. The signed authentication data may be received from the user device.

Step 560 of method 500 comprises verifying access criteria. The access criteria comprise a first criterion of verifying the authority signature of the signed access authorisation data, and a second criterion of verifying that the signature of the signed authentication data is a digital signature of the user using the cryptographic key of the user.

Step 570 of method 500 comprises granting the access request in response to verifying the access criteria.

Step 510 to 540 of method 500 may be performed by a first processing system, while steps 550 to 570 of method 500 may be performed by a second processing system, different from the first processing system. The first processing system and the second processing system may form part of an access authority and an access controller, respectively, as described herein.

It will be appreciated that the term “processing system” may refer to any electronic processing device or system, or computing device or system, or combination thereof (e.g. computers, web servers, smart phones, laptops, microcontrollers, etc.), and may include a cloud computing system. The processing system may also be a distributed system. In general, processing/computing systems may include one or more processors (e.g. CPUs, GPUs), memory componentry, and an input/output interface connected by at least one bus. They may further include input/output devices (e.g. keyboard, displays, etc.). It will also be appreciated that processing/computing systems are typically configured to execute instructions and process data stored in memory (i.e. they are programmable via software to perform operations on data).

Optional embodiments may also be said to broadly include the parts, elements, steps and/or features referred to or indicated herein, individually or in any combination of two or more of the parts, elements, steps and/or features, and where specific integers are mentioned which have known equivalents in the art to which the invention relates, such known equivalents are deemed to be incorporated herein as if individually set forth.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

The claims:

1. A system for access control, the system comprising:
an access authority configured to:
receive an access request associated with a user;
determine whether the user is authorised to be granted access;
in response to determining that the user is authorised to be granted access, digitally sign access authorisation data comprising a cryptographic key of the user; and
send the signed access authorisation data to a user device associated with the user; and
an access controller configured to:
receive from the user device signed authentication data comprising the signed access authorisation data;
verify access criteria comprising:
verifying of the signature of the signed access authorisation data; and
verifying the signature of the signed authentication data using the cryptographic key of the user; and,
in response to verifying the access criteria, grant the access request.

2. The system of claim 1, wherein the access controller is configured to verify the signature of the signed authentication data through public-key cryptography, wherein the cryptographic key of the user is a user public key, and wherein the access controller is configured to verity that the signature of the signed authentication data was generated with a user private key, wherein the user public key and the user private key form a cryptographic key pair.

3. The system of claim 1, wherein the access controller is configured to verify the signature of the signed access authorisation data through public-key cryptography, wherein the access authority is configured to generate the signature of the signed access authorisation data with an authority private key, and wherein the access controller is configured to access an authority public key and to verify the signature of the signed access authorisation data using the authority public key, wherein the authority public key and the authority private key form a cryptographic key pair.

4. The system of claim 3, wherein the access authority is configured to generate the cryptographic key pair comprising the authority public key and the authority private key.

5. The system of claim 4, wherein the access controller is configured to receive the authority public key from the access authority, and to store the authority public key in a memory of the access controller.

6. The system of claim 1, wherein the access authorisation data comprises a location identifier indicative of a location which the user is authorised to access, and wherein the access criteria further comprise verifying that the location identifier corresponds to a location associated with the access controller.

7. The system of claim 1, wherein the access authority is further configured to:
determine a request time indicative of the time when the access request is received; and,
in response to determining that the request time is outside an access period, set the access authorisation data to indicate an invalid status; and
wherein the access criteria further comprise verifying that the status of the authorisation data is not invalid.

8. The system of claim 1, wherein the access controller comprises an image sensor configured to read one or more optical labels from a display device of the user device, wherein the one or more optical labels represent the signed authentication data.

9. The system of claim 8, wherein the image sensor is configured to read a sequence of two or more optical labels from the display device, wherein each of the two or more optical labels encodes a data packet representing a portion of the signed authentication data.

10. The system of claim 9, wherein each of the two or more optical labels in the sequence encodes a position number representing the position of the data packet encoded by the respective optical label in an ordered arrangement of the data packets encoded by the two or more optical labels representing the signed authentication data, and wherein the access controller is configured to reconstruct the signed authentication data by ordering the two or more data packets based on their position numbers.

11. The system of claim 8, wherein each of the one or more optical labels encodes an error-detecting code; and
wherein, for each optical label read, the access controller is configured to:
detect a presence of an error in the data derived from reading the optical label using the error-detecting code;
re-read the optical label when the error in the data is detected; and
replace the data derived from a previous reading of the optical label with data derived from re-reading the optical label.

12. The system of claim 11, wherein the error-detecting code is a cyclic redundancy check (CRC).

13. The system of claim 9, wherein the two or more optical labels are encoded as erasure codes generated from the signed authentication data.

14. The system of claim 8, wherein each of the optical labels is a matrix barcode.

15. The system of claim 1, wherein, to determine whether a user is authorised to be granted access, the access authority is configured to receive access credentials of the user, and to determine a validity of the access credentials.

16. The system of claim 1, wherein the access authorisation data further comprises timing data, and wherein the access criteria further comprise verifying that the signed access authorisation data is not expired based on the timing data of the signed access authorisation data.

17. The system of claim 1, wherein the signed authentication data further comprises timing data, wherein the access criteria further comprise verifying that the signed authentication data is not expired based on the timing data of the signed authentication data.

18. The system of claim 1, wherein the signed authentication data further comprises authentication information of the user.

19. The system of claim 1, wherein the access controller is operatively coupled to a lock, and wherein the access controller is configured to grant the access request by unlocking the lock.

20. A method for access control, the method comprising:
receiving an access request associated with a user;
determining whether the user is authorised to be granted access;
in response to determining that the user is authorised to be granted access, generating an authority signature by digitally signing access authorisation data comprising a cryptographic key of the user;
sending the signed access authorisation data to a user device associated with the user;
receiving, from the user device, signed authentication data comprising the signed access authorisation data;
verifying access criteria comprising:
verifying the authority signature of the signed access authorisation data; and
verifying that the signature of the signed authentication data is a digital signature of the user using the cryptographic key of the user; and,
in response to verifying the access criteria, granting the access request.
